(19) United States
(12) Patent Application Publication
(10) Pub. No.: US 2009/0268941 A1
(43) Pub. Date: Oct. 29, 2009

(54) VIDEO MONITOR FOR SHOPPING CART CHECKOUT

(76) Inventors: John R. French, San Diego, CA (US); Joseph F. Nebolon, Del Mar, CA (US); Robert M. Harling, Valley Center, CA (US)

Correspondence Address: NYDEGGER & ASSOCIATES, 348 OLIVE STREET, SAN DIEGO, CA, 92103, US

(21) Appl. No.: 12/108,274

(22) Filed: Apr. 23, 2008

(51) Int. Cl. G06K 9/00; G06F 17/00

(52) U.S. Cl. 382/103; 235/375

(57) ABSTRACT

A system ensures payment for the purchase of merchandise carried through a checkout aisle on the lower tray of a shopping cart. For that purpose, the system includes a controller with an embedded program for identifying a virtual structure substantially equivalent to the physical structure of the tray. Further, the system includes a sensor that determines when a cart is positioned at the checkout aisle. The system also includes a camera for creating an image of the physical structure of the tray and transmitting the image to the controller. The controller includes a means for activating the embedded program to compare the image with the virtual structure. As a result of the comparison, the controller determines whether merchandise is on the physical structure of the tray. During the comparison, the controller removes the virtual structure from the image.

### FIELD OF THE INVENTION

The present invention pertains generally to cashier monitoring and theft prevention devices and to methods of using such devices. More particularly, the present invention pertains to devices that make cashiers aware of merchandise carried on the lower trays of shopping carts at checkout locations. The present invention is particularly, but not exclusively, useful as a device that monitors a checkout location and compares an actual image of the lower tray of a shopping cart, at the checkout location, with a virtual image of a tray structure to determine whether merchandise is present on the tray.

### BACKGROUND OF THE INVENTION

Shoplifting continues to be a major issue for retailers. In fact, more than $13 billion worth of goods are stolen from retailers in the U.S. each year, i.e., more than $25 million worth of goods per day. While shoplifting often connotes clandestine attempts to hide and carry goods out of the store, often goods are stolen in a more patent manner. Specifically, goods may be kept on the lower tray of a shopping cart during checkout, and then carried out of the store without being paid for. Due to the non-concealed nature of this act, the shoplifter can allege innocence if apprehended for theft. Further, cashiers at the checkout counter can purposely fail to scan goods on the bottom shelf of the shopping cart as a “sweetheart deal” for family and friends. This causes particular financial loss for the store when such thefts involve expensive goods; for example, baby formula.

In light of the above, it is an object of the present invention to provide a system and method for preventing non-payment for goods carried on the lower tray of a shopping cart to a checkout location. Another object of the present invention is to provide a system that alerts a cashier at a checkout location to inspect the lower tray of a presumably empty shopping cart. Still another object of the present invention is to provide a system that monitors the behavior of cashiers at check out locations. Still another object of the present invention is to provide a system that captures an actual image of the lower tray of a presumably empty cart and compares it with a stored virtual tray structure to determine whether the tray is carrying goods. It is another object of the present invention to provide a method and system that is easy to implement, cost effective and simple to use.

### SUMMARY OF THE INVENTION

In accordance with the present invention, a system is provided for determining whether merchandise has been loaded onto the lower tray of a shopping cart. This determination is made as the cart passes through a checkout aisle at a retail facility. In the system, the lower tray of each cart has a known physical structure. Further, in the system, a controller is provided with an embedded program that identifies a virtual structure substantially equivalent to the physical structure of the tray.

For purposes of the present invention, the system is provided with a sensor for establishing when the cart is at the checkout aisle. This sensor is electronically connected to the controller. Also, the system is provided with a camera at the checkout aisle for creating an image of the physical structure of the tray, and of any merchandise that has been loaded onto the tray. The camera is electronically connected to the controller to communicate the actual image of the tray (loaded or unloaded) to the controller. Moreover, the camera is connected to a display monitor (e.g. CRT) that provides a visual presentation of the actual image. Further, the system includes an activation mechanism to automatically instruct the embedded program in the controller to compare the actual image with the virtual structure and thereby determine whether merchandise is present on the tray. In one mode of operation, during the comparison, the controller effectively removes the virtual structure from the image to more clearly visualize the merchandise that has been loaded onto the tray.

During operation of an embodiment of the system of the present invention, a cart enters the checkout aisle causing the camera to capture an actual (real time) image of the tray. This actual image is then stored by the controller, and is marked with a date-time-location stamp. Further, at an appropriate time prior to completing the transaction at the checkout aisle, the controller compares the actual image to the virtual structure of the controller's embedded program. This comparison is used to determine whether any merchandise is on the tray. The controller may then activate an alarm if merchandise remains on the tray and is not paid or otherwise accounted for.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective view of an embodiment of a system for preventing non-payment for goods transported on the lower tray of a shopping cart in accordance with the present invention;

FIG. 2 is a schematic of the components of the system shown in FIG. 1; and

FIG. 3 is an operational flow chart illustrating the method of an embodiment of the present invention.

### DESCRIPTION OF THE PREFERRED EMBODIMENTS

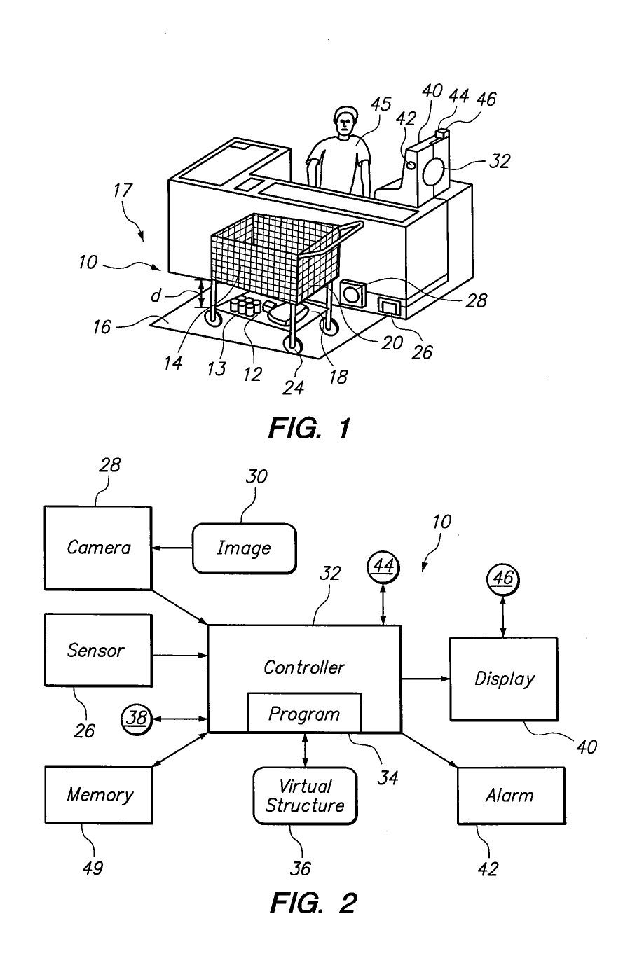

Referring initially to FIG. 1, a system for ensuring payment for purchases is shown, and is generally designated 10. More specifically, the system 10 ensures payment for merchandise 12 transported on the lower tray 13 of a carrier such as a shopping cart 14. In particular, the system 10 is concerned with whether merchandise 13 is being carried by the cart 14 when at a predetermined site such as a checkout location 16 in a retail facility 17. As shown, the shopping cart 14 includes a basket 20 and a plurality of wheels 24. Importantly, the tray 13 has a physical structure 18 for holding merchandise 12 below the basket 20. Specifically, the tray 13 is positioned at a distance “d” below the basket 20.

Still referring to FIG. 1, the system 10 includes a sensor 26 for establishing when the shopping cart 14 is at the checkout location 16. Depending on the desired configuration, the sensor 26 may be a radio frequency (RF) sensor, a motion sensor, an infrared (IR) sensor, or similar device. Also, the system 10 includes a plurality of video cameras 28 for creating an image 30 (see FIG. 2) of the physical structure 18 of the tray 13 at the checkout location 16. In certain embodiments, each camera 28 may be positioned at a different perspective relative to the checkout location 16 to eliminate blind spots in the tray 13. For the present invention, the image 30 includes any merchandise 12 being carried by the physical structure 18.

In addition to the sensor 26 and camera 28, the system 10 includes a controller 32. Importantly, the controller 32 is electronically connected to both the sensor 26 and the camera 28. As a result, the controller 32 is notified when a shopping cart 14 is positioned at the checkout location 16. Further, the controller 32 receives the image 30 of the physical structure 18 of the tray 13 from the camera 28. As shown in FIG. 2, the controller 32 includes an embedded program 34 that identifies a virtual structure 36 substantially equivalent to the physical structure 18 of the tray 13. Also, the controller 32 is provided with an activation mechanism 38. Specifically, the activation mechanism 38 is mounted on the controller 32 for activating the embedded program 34 to compare the image 30 with the virtual structure 36. In this manner, the controller 32 determines whether merchandise 12 is present in the physical structure 18 of the tray 13. During this comparison, the controller 32 preferably removes the virtual structure 36 from the image 30. It is to be appreciated, however, that the presence of merchandise 12 on the tray 13 can be determined in any manner well known in the art. It is also to be appreciated that the controller 32 can be remotely located away from the checkout location 16, rather than located at the location 16 as shown in FIG. 1.

In FIGS. 1 and 2, it can be seen that the system 10 includes a display device 40, such as a CRT monitor, LCD or any other type display monitor known in the pertinent art, that is connected to the camera 28. For the present invention, the display device 40 provides a visual presentation of the image 30. Also, the system 10 is provided with an alarm 42 for indicating when merchandise 12 is present on the tray 13 and has not been purchased or otherwise accounted for. Further, the system 10 includes a switch 44 connected to the controller 32 to allow a cashier 45 to inform the controller 32 of a payment for the merchandise 12 held on the tray 13. In effect, the switch 44 may be used to deactivate the alarm 42. Also, the system 10 includes a switch 46 connected to the display device 40 for clearing the display device 40 after a purchase or after all merchandise 12 has been properly accounted for.

In addition to the virtual structure 36 substantially equivalent to the physical structure 18 of the tray 13, the embedded program 34 in the controller 32 may also be able to identify virtual entities (not necessarily shown) that may or may not be substantially equivalent to specific merchandise 12. As a result, the controller 32 can review the register record and determine whether any merchandise 12 remaining on the tray 13 needs to be accounted for. Also, because heavy merchandise 12 is often manually entered into the register for purchase, without being removed from the tray 13, the entry of such heavy merchandise 12 may be communicated to the controller 32. When an entry is communicated to the controller 32, the controller 32 may note that certain merchandise 12 on the tray 13 has been purchased. As shown, the controller 32 is connected to a memory 49 for recording all images and transactions. The memory 49 may be a record storage unit onsite or a server at a central location. Further, the controller 32 may communicate with the memory 49 through a direct connection, through a wireless communication or through an internet connection.

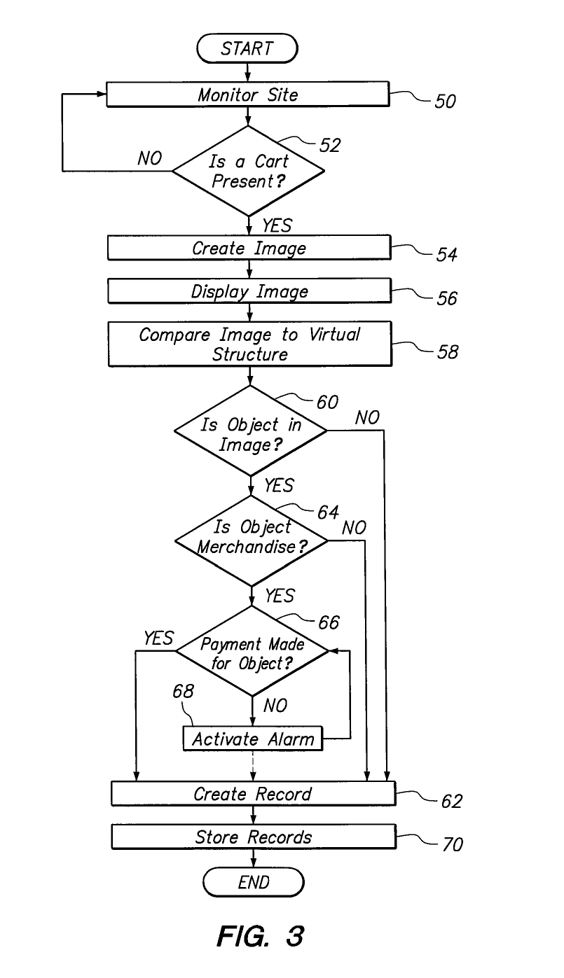

Referring now to FIG. 3, the operation of an embodiment of the system 10 may be understood. In accordance with the methodology shown in FIG. 3, the sensor 26 monitors the checkout location 16 to determine whether a cart 14 is present (action block 50). As shown in inquiry block 52, if no cart 14 is positioned at the checkout location 16, then the sensor 26 continues monitoring. When a cart 14 is positioned at the checkout location 16, the camera 28 is activated to create an image of the tray 13 and any merchandise 12 thereon (action block 54). Activation may be automatically triggered by the sensor 26, performed according to a schedule, or caused by actions of a cashier 45. Regardless of the activation method employed, the image 30 is communicated to and displayed by the display device 40 (action block 56). Further, the image 30 is communicated to the controller 32 which utilizes the embedded program 34 to compare the image 30 to the virtual structure 36 (action block 58). Specifically, the program 34 disregards the virtual structure 36 from the image 30 (e.g. by removal of the virtual structure 36 from the image 30). In this manner, the controller 32 determines whether any objects, including merchandise 12, are on the tray 13.

As shown in inquiry block 60, if no objects are present in the image 30 of the tray 13, then a record is created by the controller 32 indicating such (action block 62). In this case, there is no need to activate the display device 40. On the other hand, if an object is present on the tray 13, then it must be determined whether the object is merchandise 12 at inquiry block 64. If the object is determined to not be merchandise 12, then the controller 32 creates a record (action block 62). If the object is determined to be merchandise 12, then it may be necessary to determine whether payment for the merchandise 12 is required (inquiry block 66). If payment is required and has not been made, the controller 32 activates the alarm 42 (action block 68) and a record is created (action block 62). Further, the operation returns to inquiry block 66 until a payment has been made. When payment is made, the controller 32 creates a record of payment (action block 62).

When all merchandise 12 in the tray 13 has been accounted for, the records created at action block 62 are stored by the controller 32 or by a secondary storage or oversight system (action block 70). Such records may be marked by the controller 32 with a date-time-location stamp. Because records include a date-time-location stamp, the performance of a specific cashier 45 may be audited. In order to deactivate the alarm 42, the switch 44 is used to inform the controller 32 that the transaction has been completed. Further, the switch 46 is used to clear the display device 40 after payment for the merchandise 12.

While the particular Video Monitor for Shopping Cart Checkout as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A system which comprises:
a controller having an embedded program, wherein the embedded program identifies a virtual structure;
a carrier formed with a tray having a physical structure for holding merchandise therein, wherein the physical structure of the tray is substantially equivalent to the virtual structure in the embedded program;
a sensor for establishing when the carrier is at a predetermined site;
a means for creating an image of the physical structure at the site, with the image including any merchandise being held by the physical structure, and for transferring the image to the controller; and
a means mounted on the controller for activating the embedded program to compare the image with the virtual structure to determine whether merchandise is present on the physical structure of the tray.

2. A system as recited in claim 1 wherein a comparison by the embedded program in the controller is made by removing the virtual structure from the image.

3. A system as recited in claim 2 further comprising a display device connected to the image creating means to provide a visual presentation of the image at the site including any objects of merchandise held by the physical structure on the tray.

4. A system as recited in claim 3 further comprising a switching means connected with the controller to indicate the purchase of merchandise held on the physical structure of the tray.

5. A system as recited in claim 4 wherein the switching means comprises:
a first switch for informing the controller of a payment for the merchandise; and
a second switch connected to the display device for clearing the display device after a purchase.

6. A system as recited in claim 3 wherein the display device is a CRT monitor.

7. A system as recited in claim 1 wherein the carrier is a shopping cart.

8. A system as recited in claim 7 wherein the cart has a plurality of wheels and a basket, with the tray being positioned at a distance “d” below the basket of the shopping cart.

9. A system as recited in claim 1 wherein the sensor is selected from a group consisting of a radio frequency (RF) sensor, a motion sensor, and an infrared (IR) sensor.

10. A system as recited in claim 1 wherein the site is a checkout aisle in a retail facility.

11. A system as recited in claim 1 wherein the image creating means is at least one video camera.

12. A system which comprises:
a controller including a stored virtual structure;
a carrier formed with a tray having a physical structure for holding merchandise therein, wherein the physical structure of the tray is substantially equivalent to the stored virtual structure;
a camera for creating an image of the physical structure, with the image including any merchandise being held by the physical structure, and for transferring the image to the controller; and
a means mounted on the controller for activating comparison of the image with the virtual structure to determine whether merchandise is present on the physical structure of the tray.

13. A system as recited in claim 12 further comprising a sensor for establishing when the carrier is at a predetermined site, wherein the camera creates the image of the physical structure in response to the sensor.

14. A system as recited in claim 12 wherein the comparison by the embedded program in the controller is made by removing the virtual structure from the image.

15. A system as recited in claim 12 further comprising a display device connected to the image creating means to provide a visual presentation of the image at the site including any objects of merchandise held by the physical structure of the tray.

16. A system as recited in claim 12 further comprising a switch connected with the controller to indicate the purchase of merchandise held on the physical structure of the tray.

17. A system as recited in claim 12 wherein the switch comprises:
a first switch for informing the controller of a payment for the merchandise; and
a second switch connected to the display device for clearing the display device after a purchase.

18. A method which comprises the steps of:
providing a system including a controller including a stored virtual structure, a carrier formed with a tray having a physical structure for holding merchandise therein, wherein the physical structure of the tray is substantially equivalent to the stored virtual structure, and a camera for creating an image of the physical structure and for transferring the image to the controller, with the image including any merchandise being held by the physical structure;
monitoring a checkout location for the cart;
creating an image of the physical structure of the tray and any merchandise thereon when the cart is positioned at the checkout location; and
comparing the image with the virtual structure to determine whether merchandise is present on the physical structure of the tray.

19. A method as recited in claim 18 wherein the comparing step is performed by removing the virtual structure from the image.

20. A method as recited in claim 19 wherein the system includes a display device connected to the camera and wherein the method further comprises the step of providing a visual presentation of the image including any merchandise held by the physical structure of the tray.
